(19) United States
(12) Patent Application Publication
(10) Pub. No.: US 2024/0007579 A1
(43) Pub. Date: Jan. 4, 2024

(54) IMAGE PROCESSING DEVICE AND IMAGE PROCESSING METHOD

(71) Applicant: KYOCERA Document Solutions Inc., Osaka (JP)

(72) Inventor: Harrel June CENIZA, Osaka (JP)

(73) Assignee: KYOCERA Document Solutions Inc., Osaka (JP)

(21) Appl. No.: 18/250,115

(22) PCT Filed: Nov. 1, 2021
(86) PCT No.: PCT/JP2021/040231

§ 371 Date: Apr. 21, 2023

(30) Foreign Application Priority Data
Nov. 5, 2020 (JP) 2020-184862

(51) Int. Cl. H04N 1/409; H04N 1/60; H04N 1/62

(52) U.S. Cl. CPC H04N 1/4092; H04N 1/6022; H04N 1/62

(57) ABSTRACT

An image processing device includes a storage portion and a pixel value adjustment portion. The storage portion stores image data. Based on a pixel value, the pixel value adjustment portion assigns labels to pixels and divides the image data into a plurality of regions. The pixel value adjustment portion determines whether or not each of components that is a cluster of pixels assigned identical ones of the labels forms a character. The pixel value adjustment portion adjusts a pixel value of each of character pixels, which are pixels constituting the each of components when determined to form a character, so that an increased density is obtained.

### CROSS-REFERENCE TO RELATED APPLICATIONS

This application is a national stage of International Application No. PCT/jP2021/040231, filed Nov. 1, 2021, which claims the benefit of Japanese Application No. 2020-184862, filed Nov. 5, 2020, in the Japanese Patent Office, the disclosures of which are incorporated herein by reference.

### TECHNICAL FIELD

The present invention relates to an image processing device and an image processing method for processing image data including characters.

### BACKGROUND ART

In a case of processing image data including a character (character image), there may be performed a process for enhancing an edge of the character. Such image processing of edge enhancement performed on a photographic image, however, may impair beauty of the image and a smooth gray-scale variation thereof. To address this issue, Patent Literature 1 describes an example of a device that performs region-specific image processing.

Specifically, Patent Literature 1 describes a color scanner that optically reads each unit region of an original document, acquires image data split into a plurality of color components, performs, based on a variation in luminance value of each pixel in the image data, region discrimination between a character region and a non-character region, and includes a first luminance value corrector, a region discriminator, and an image processor. In a case of acquiring monochrome image data, the first luminance value corrector performs, with respect to a part of the image data corresponding to at least one of the color components, luminance value correction in which a luminance value of each pixel is offset by a preset prescribed amount, the region discriminator performs the region discrimination based on the part of the image data subjected to the luminance value correction by the first luminance value corrector, and the image processor performs, with respect to another part of the image data corresponding to at least one of the other color components, image processing corresponding to a region type discriminated by the region discriminator and outputs the image data as the monochrome image data (Patent Literature 1: claim 1).

### CITATION LIST

### Patent Literature

Patent Literature 1: Japanese Unexamined Patent Application Publication No. 2005-295345

### SUMMARY OF INVENTION

### Technical Problem

There is an image processing device that performs a job based on image data. For example, based on image data, printing of a document may be performed. A printing job based on image data obtained by reading an original document may be referred to as a copy job. There may be also performed transmission of image data of a document.

If definition of a character (character image) included in image data can be increased, a character portion will look beautiful. In such a case, it is possible to improve an appearance of the character portion, thus providing increased image quality. Typically, a character is described in a color denser than a color of a sheet (background). In order, therefore, to increase definition of a character, conventionally, image processing for adjusting contrast or brightness may be performed.

Performing image processing for increasing (enhancing) contrast or brightness adjustment in which entire histograms are shifted may rather decrease a density of a character portion. For example, a density of a character in a relatively bright color may be decreased. As a result, the color of the character may become brighter (lighter), the character may fade, or a contour thereof may become blurred. That is, there is a problem that it may not be possible to increase ease of reading a character even by conventionally performed contrast or brightness adjustment. The ease of reading a character could rather be decreased.

Patent Literature 1 is advantageous in that image processing is performed so as to be suitable for the character region and the non-character region, respectively. There could be a case, however, where it is not possible to increase the ease of reading a character.

In view of the above-described problem, the present invention provides, regardless of a density of each character in image data, an increased density of the each character, an emphasized contour thereof, and increased ease of reading the same.

### Solution to Problem

An image processing device according to the present invention includes a storage portion and a pixel value adjustment portion. The storage portion stores image data. Based on a pixel value of each of pixels included in the image data, the pixel value adjustment portion assigns labels to the pixels so as to divide the image data into a plurality of regions. With respect to each of components that is, among the pixels, a cluster of pixels assigned identical ones of the labels, the pixel value adjustment portion determines whether or not the each of components forms a character. The pixel value adjustment portion adjusts a pixel value of each of character pixels, which are pixels constituting the each of components when determined to form a character, so that an increased density is obtained.

### Advantageous Effects of Invention

According to the present invention, regardless of a density of each character in image data, it is possible to provide an increased density of the each character, a clearly identifiable contour thereof, and increased ease of reading the same.

### BRIEF DESCRIPTION OF DRAWINGS

FIG. 1 is a view showing an example of a multi-functional peripheral according to an embodiment.

FIG. 2 is a view showing an example of image data.

FIG. 3 is a view showing an example of a result of a division process performed by the multi-functional peripheral according to the embodiment, also illustrating a cluster of pixels outside contours of characters,

FIG. 4 is a view showing the example of the result of the division process performed by the multi-functional peripheral according to the embodiment, also illustrating one of data portions resulting from dividing (extracted from) the image data.

FIG. 5 is a view showing the example of the result of the division process performed by the multi-functional peripheral according to the embodiment, also illustrating another one of the data portions resulting from dividing (extracted from) the image data.

FIG. 6 is a view showing the example of the result of the division process performed by the multi-functional peripheral according to the embodiment, also illustrating still another one of the data portions resulting from dividing (extracted from) the image data.

FIG. 7 is a view showing the example of the result of the division process performed by the multi-functional peripheral according to the embodiment, also illustrating yet another one of the data portions resulting from dividing (extracted from) the image data.

FIG. 8 is a view showing an example of a labelling process according to the embodiment, also illustrating a state before the labelling process is performed, in which the image data has been divided into a plurality of regions.

FIG. 9 is a view showing the example of the labelling process according to the embodiment, also illustrating a state after the labelling process has been performed, in which the image data has been divided into the plurality of regions.

FIG. 10 is a view showing an example of a process flow of a job involving a readability improving process performed in the multi-functional peripheral according to the embodiment.

FIG. 11 is a view showing an example of an adjustment setting screen according to the embodiment.

FIG. 12 is a view showing an example of a state before pixel value adjustment is performed in the multi-functional peripheral according to the embodiment.

FIG. 13 is a view showing an example of a state after the pixel value adjustment has been performed in the multi-functional peripheral according to the embodiment.

### DESCRIPTION OF EMBODIMENT

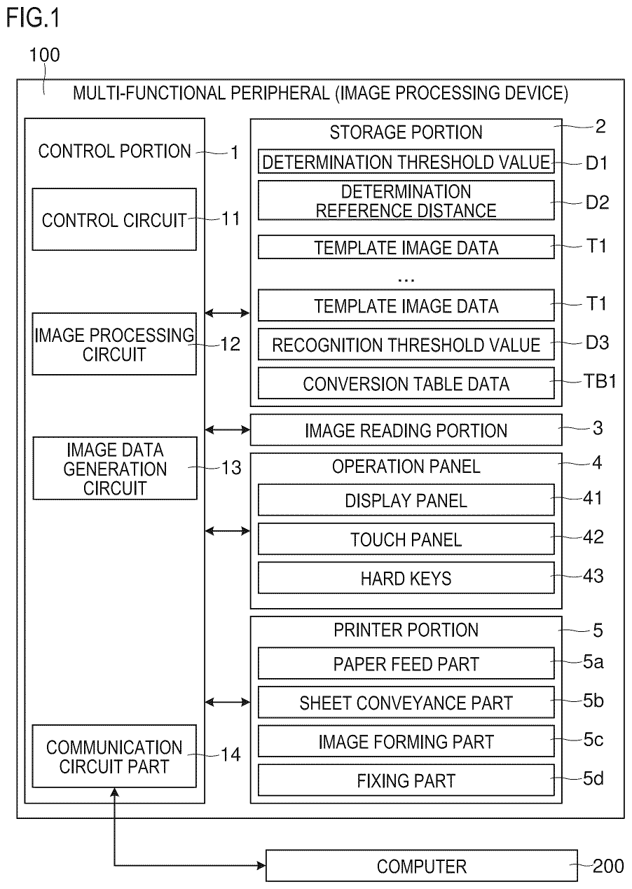

With reference to FIG. 1 to FIG. 13, a description is given of an image processing device according to the present invention. In the description, a multi-functional peripheral 100 is used as an example of the image processing device. The multi-functional peripheral 100 serves also as an image forming apparatus. Factors such as configurations and arrangements described herein are not intended to limit the scope of the invention but are merely examples for describing the invention.

(Overview of Multi-Functional Peripheral 100)

First, with reference to FIG. 1, there is described an example of the multi-functional peripheral 100 according to an embodiment. FIG. 1 is a view showing an example of the multi-functional peripheral 100 according to the embodiment.

The multi-functional peripheral 100 includes a control portion 1, a storage portion 2, an image reading portion 3, an operation panel 4, and a printer portion 5. The control portion 1 controls itself, the storage portion 2, the image reading portion 3, the operation panel 4, and the printer portion 5. The control portion 1 includes a control circuit 11, an image processing circuit 12, an image data generation circuit 13, and a communication circuit part 14. For example, the control portion 1 is a substrate including a plurality of circuits. For example, the control circuit 11 is formed of a CPU. The control circuit 11 performs arithmetic computations and processing related to control. The image processing circuit 12 performs image processing.

The multi-functional peripheral 100 includes, as the storage portion 2, a ROM, a RAM, and a storage. For example, the storage portion 2 stores control programs and various types of data. For example, the storage is formed of a mass-storage device. The storage is capable of storing image data in a non-volatile manner. For example, the storage is formed of either or both of an HDD and an SSD.

The multi-functional peripheral 100 includes a pixel value adjustment portion that performs a readability improving process. In performing the readability improving process, the pixel value adjustment portion performs a division process, a determination process, and a density adjustment process. In the division process, the pixel value adjustment portion assigns labels to pixels and divides image data based on the labels. The pixel value adjustment portion performs a labeling process as the division process. In the determination process, the pixel value adjustment portion determines whether or not each of components 6 (regions) resulting from the division forms a character. The components 6 are each a cluster of pixels assigned identical labels. In the density adjustment process, the pixel value adjustment portion adjusts a pixel value of each of character pixels, which are pixels constituting one of the components 6 determined to form a character, so that an increased density is obtained.

The control portion 1 can be used as the pixel value adjustment portion. For example, the control portion 1 reads image data into the RAM and subjects the image data to the readability improving process. The control circuit 11 may perform the readability improving process. The image processing circuit 12 may perform the readability improving process. A configuration may be adopted in which a part of the readability improving process is performed by the control circuit 11 and a rest thereof is performed by the image processing circuit 12. A dedicated circuit that performs the readability improving process may be provided in the control portion 1. The dedicated circuit may also be provided outside the control portion 1.

The image reading portion 3 includes an original document platen, a light source (lamp), a lens, and an image sensor. In the image reading portion 3, a document (original document) desired to be read can be placed on the original document platen. The light source applies light to the original document platen and the document thus placed thereon. The lens guides reflected light from the original document to the image sensor. The image sensor includes an array of light-receiving elements. For example, the image sensor is formed of a line sensor. Each of the light-receiving elements receives the reflected light and outputs, as an analog image signal, a voltage corresponding to an amount of the light received. The light source, the lens, and the image sensor are formed as a unit. The image reading portion 3 includes a motor and a wire for moving the unit. When reading the original document, the image reading portion 3 moves the unit in a sub-scanning direction (a direction orthogonal to a direction in which the light-receiving elements are arranged) and reads the entire original document. The image reading portion 3 is capable of reading in colors.

Based on the analog image signal outputted by the image reading portion 3 as a result of the image reading portion 3 reading the original document, the image data generation circuit 13 generates image data of the original document. For example, the image data generation circuit 13 includes an amplification circuit, an offset circuit, and an A/D conversion circuit. The amplification circuit amplifies the analog image signal. The offset circuit adjusts a voltage value of the analog image signal inputted to the A/D conversion circuit. The A/D conversion circuit changes the analog image signal into digital data so as to generate image data. For example, the image data generation circuit 13 generates image data (raster data) in an RGB bitmap format.

The communication circuit part 14 communicates with a computer 200. For example, the computer 200 is a personal computer or a server. The communication circuit part 14 includes a communication connector, a communication control circuit, and a communication memory. The communication memory stores communication software and data. The communication circuit part 14 is capable of data transmission to and data reception from the computer 200.

The multi-functional peripheral 100 includes the operation panel 4. The operation panel 4 includes a display panel 41, a touch panel 42, and hard keys 43. The control portion 1 controls display on the display panel 41. The control portion 1 controls the display panel 41 to display a screen and an image. The control portion 1 performs control so that an operation image is displayed. Examples of the operation image include a button (soft key) and a tab. Based on an output of the touch panel 42, the control portion 1 recognizes a type of the operation image operated. Furthermore, the control portion 1 recognizes an operated one of the hard keys 43. The operation panel 4 accepts a setting operation by a user. The control portion 1 recognizes contents of job setting made on the operation panel 4. The control portion 1 controls the multi-functional peripheral 100 to operate in accordance with the contents of job setting.

Specifically, the operation panel 4 accepts a selection as to whether or not to perform the readability improving process in a job. When a selection has been made to perform the readability improving process, the control portion 1 performs the readability improving process with respect to image data to be used for the job. Further, based on the image data subjected to the readability improving process, the control portion 1 performs the job. When a selection has been made not to perform the readability improving process, the control portion 1 does not perform the readability improving process with respect to the image data to be used for the job.

The printer portion 5 includes a paper feed part 5a, a sheet conveyance part 5b, an image forming part 5c, and a fixing part 5d. The paper feed part 5a includes a sheet cassette and a paper feed roller. A sheet bundle is placed in the sheet cassette. In a printing job, the control portion 1 controls the paper feed roller to rotate to feed a sheet. The sheet conveyance part 5b includes a conveyance roller pair. In the printing job, the control portion 1 controls the conveyance roller pair to rotate so that the sheet conveyance part 5b conveys a sheet. The control portion 1 controls the image forming part 5c to form a toner image based on image data.

The image forming part 5c includes an exposure device, an image forming unit, and an intermediate transfer part. As the image forming unit, a plurality of image forming units is provided. Each of the image forming units includes a photosensitive drum, a charging device, and a developing device. For example, the image forming part includes an image forming unit that forms a black toner image, an image forming unit that forms a cyan toner image, an image forming unit that forms a magenta toner image, and an image forming unit that forms a yellow toner image. The image forming part 5c is capable of color printing. The intermediate transfer part includes a rotary intermediate transfer belt and a secondary transfer roller. The image forming units primarily transfer the thus formed toner images on the intermediate transfer belt. The secondary transfer roller secondarily transfers the toner images on a sheet conveyed thereto.

The control portion 1 controls the fixing part 5d to fix the toner images transferred on the sheet. The fixing part 5d includes a heater and a plurality of fixing rotors. The toner images are fixed on the sheet by heat and pressure applied by the fixing part 5d. The control portion 1 controls the sheet conveyance part 5b to discharge the sheet after being subjected to the fixing to outside the device.

(Division Process)

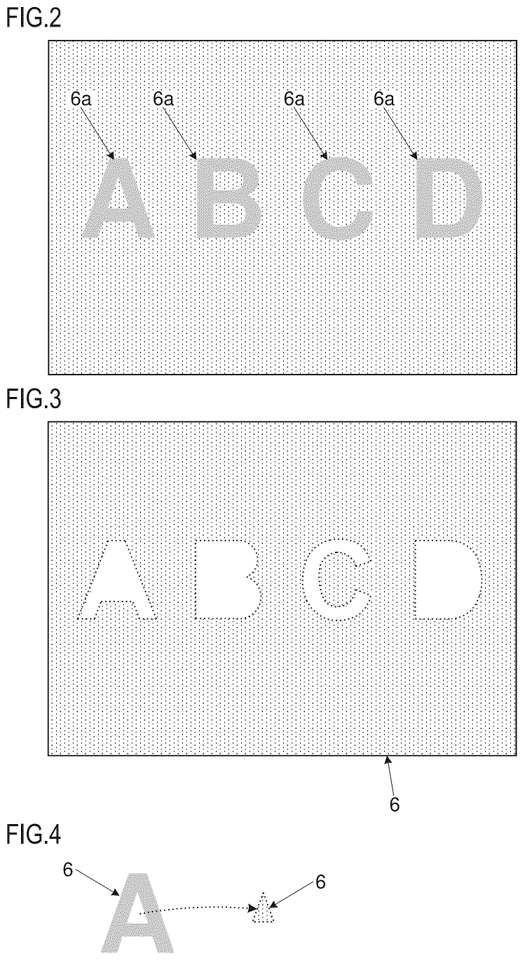

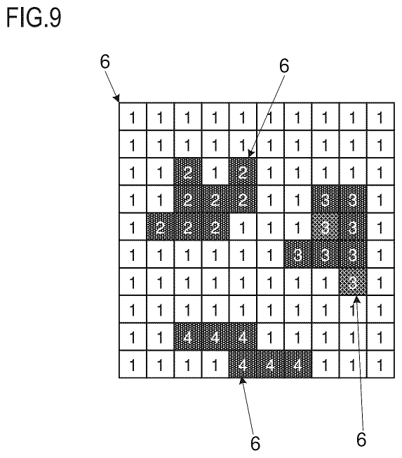

Next, with reference to FIG. 2 to FIG. 9, a description is given of an example of a division process performed by the control portion 1 according to the embodiment. FIG. 2 is a view showing an example of image data. FIG. 3 to FIG. 7 are views showing an example of a result of a division process performed by the multi-functional peripheral 100 according to the embodiment. FIG. 8 and FIG. 9 are views showing an example of a labeling process according to the embodiment.

The control portion 1 performs the division process for dividing image data into a plurality of regions. In performing the division process, the control portion 1 performs the labeling process. The labeling process may be referred to also as a CCL (connected component labeling) process. In the following description, each cluster of pixels (each of the regions resulting from the division) assigned identical labels is referred to as a component 6.

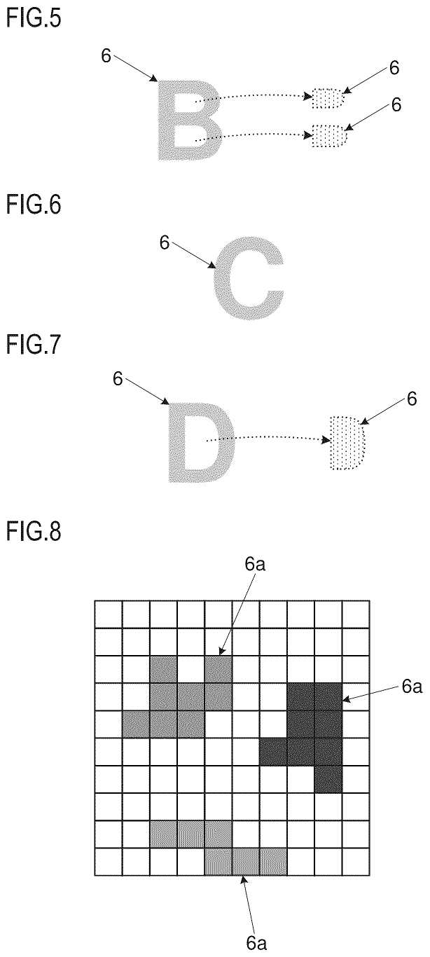

For example, image data of a document includes a character. The character is expressed by using a figure formed of concatenated (connected) pixels having equal or nearly equal pixel values. Herein, such a figure obtained by concatenating pixels having equal or nearly equal pixel values is referred to as a concatenated FIG. 6a. In a case where image data includes a sentence, the image data includes a plurality of concatenated FIG. 6a.

In performing the labeling process, the control portion 1 assigns different labels to figures concatenated to each other. For example, the control portion 1 uses a numeral (number) as a label. The control portion 1 assigns a label “1” to a first concatenated FIG. 6a. Every time a new concatenated FIG. 6a is detected, the numeral used as the label is increased by 1. By this labeling, it is possible to count up the number of the concatenated FIG. 6a. In other words, it is possible to grasp, based on the numeral used as the label, how many regions have resulted from dividing image data. FIG. 8 and FIG. 9 show an example of the labeling process. The concatenated FIG. 6a (each cluster of pixels) of identically labeled pixels corresponds to the component 6. FIG. 8 illustrates a state before the labeling process is performed, in which the image data has been divided into a plurality of regions. FIG. 9 illustrates a state after the labeling process has been performed, in which the image data has been divided into the plurality of regions.

The control portion 1 is capable of performing the labeling process with respect to color image data. Prior to the labeling process, the control portion 1 may perform image processing for smoothing image data. The control portion 1 may eliminate noise included in the image data by the smoothing process.

In performing the labeling process, the control portion 1 designates one of pixels in image data as a pixel of interest. The control portion 1 designates all the pixels as pixels of interest. The control portion 1 sequentially switches the pixels of interest. Each of the pixels of interest is subjected to processes described below.

(First Process) The control portion 1 checks whether or not there is any labeled pixel in eight directions (up, down, left, right, upper left, upper right, lower left, and lower right) around a pixel of interest. The checking may be performed in four directions (up, down, left, and right) instead of the eight directions. In a case where there is no labeled pixel, a second process is performed. In a case where there is only one labeled pixel, a third process is performed. In a case where there is a plurality of labeled pixels, a fourth process is performed.

(Second Process) The control portion 1 assigns a new label (a label that is a number obtained by increasing the number used as the label by 1) to the pixel of interest.

(Third Process) Based on respective pixel values of the labeled pixel found and the pixel of interest, the control portion 1 determines whether or not to assign a label identical to that of the labeled pixel. When it is determined to assign the identical label, the control portion 1 assigns the label identical to that of the labeled pixel to the pixel of interest. When it is determined not to assign the identical label, the control portion 1 assigns a new label to the pixel of interest.

For example, the control portion 1 may determine a luminance value of the pixel of interest and a luminance value of the labeled pixel and determine to assign the identical label when an absolute value of a difference between the luminance values is not more than a predetermined determination threshold value D1. The storage portion 2 stores the determination threshold value D1 in a non-volatile manner (see FIG. 1). The control portion 1 may determine not to assign the identical label when the absolute value of the difference between the luminance values is higher than the determination threshold value D1. Here, the control portion 1 is capable of determining a luminance value of each pixel based on a pixel value thereof. The control portion 1 may multiply a pixel value of a pixel for each color component by a prescribed coefficient and determine a total value of thus determined products as the luminance value.

Furthermore, the control portion 1 may determine an inter-color distance between a pixel value of the pixel of interest and a pixel value of the labeled pixel and, based on the inter-color distance, determine whether or not to assign the identical label. For example, the control portion 1 may determine a difference between the pixel values for each of color components of R, G, and B, square the thus determined differences, determine a total value of such squared values, and determine a square root of the total value as the inter-color distance. Furthermore, the control portion 1 may determine a difference between the pixel values for each of the color components of R, G, and B, determine an absolute value of the difference for the each of the color components, and determine a total value of the thus determined absolute values as the inter-color distance. The control portion 1 may determine to assign the identical label when the inter-color distance is not more than a predetermined determination reference distance D2. The storage portion 2 stores the determination reference distance D2 in a non-volatile manner (see FIG. D. The control portion 1 may determine not to assign the identical label when the inter-color distance is higher than the determination reference distance D2.

(Fourth Process) The control portion 1 selects, from among a plurality of labeled pixels, a labeled pixel having a pixel value most nearly equal to that of the pixel of interest. In the following description, for the sake of convenience of explanation, a labeled pixel having a pixel value most nearly equal to that of the pixel of interest is referred to as a “comparison target pixel.”

The control portion 1 may select, from among the plurality of labeled pixels, a pixel having a most nearly equal luminance value as the comparison target pixel.

Further, the control portion 1 may determine to assign a label identical to that of the comparison target pixel when an absolute value of a difference between a luminance value of the pixel of interest and a luminance value of the comparison target pixel is not more than the determination threshold value D1. The control portion 1 may determine to assign a new label when the absolute value of the difference between the luminance values is higher than the determination threshold value D1.

Furthermore, the control portion 1 may determine a difference between a pixel value of the pixel of interest and a pixel value of the labeled pixel for each of the color components of R, G, and B, based on the thus determined differences, determine the inter-color distance, and select a labeled pixel having a minimum inter-color distance as the comparison target pixel. The inter-color distance may be determined similarly to the manner described above under (Third Process).

Further, the control portion 1 may determine to assign the identical label when the inter-color distance between a pixel value of the pixel of interest and a pixel value of the comparison target pixel is not more than the determination reference distance D2. The control portion 1 may determine not to assign the identical label when the inter-color distance is higher than the determination reference distance D2. The inter-color distance may be determined similarly to the manner described above under (Third Process).

The control portion 1 is not limited in terms of how ale labeling process is performed to the above-described manner. The control portion 1 may assign identical labels to pixels connected to each other (adjoining each other) as having equal pixel values. In this case, each component 6 (region) in image data is likely to be reduced in size. Further, the control portion 1 may perform an integration process with respect to labeled components 6. For example, the control portion 1 may integrate with each other components 6 having a predetermined inter-color distance therebetween, which is smaller than an integration threshold value stored in the storage portion 2. This makes it possible to connect components 6 of a substantially identical color.

FIG. 2 shows an example of image data to be subjected to the labeling process. FIG. 2 illustrates an example of image data in which four characters (alphabets) “A,” “B,” “C,” and “D” are arranged in a single page. The control portion 1 is capable of performing the labeling process with respect to image data obtained as a result of the image reading portion 3 reading an original document. For example, the control portion 1 performs the labeling process with respect to color image data (image data in an RGB format) obtained by reading an original document.

FIG. 3 to FIG. 7 show an example of a result of the labeling process performed by the control portion 1 with respect to the image data shown in FIG. 2. For example, the control portion 1 assigns identical labels to pixels (pixels belonging to a background) outside contours of the alphabets (characters). As a result, the control portion 1 recognizes a cluster of the pixels outside the contours of the alphabets (characters) as one component 6. FIG. 3 shows a cluster of pixels (component 6) outside the alphabets resulting from dividing (extracted from) the image data (see FIG. 2).

FIG. 4 shows a data portion representing the alphabet “A,” which results from dividing (is extracted from) the image data (see FIG. 2). With respect to this data portion, in the labeling process, the control portion 1 assigns identical labels to a series (cluster) of pixels representing the character (shape of) “A.” Furthermore, the control portion 1 also assigns other labels to a triangle in a background color inside “A.” As a result, the control portion 1 recognizes the cluster of pixels representing the character “A” as one component 6. Furthermore, the control portion 1 recognizes the triangle inside “A” as another component 6.

FIG. 5 shows a data portion representing the alphabet “B,” which results from dividing (is extracted from) the image data (see FIG. 2). With respect to this data portion, in the labeling process, the control portion 1 assigns identical labels to a cluster of pixels representing the character (shape of) “B.” Furthermore, the control portion 1 assigns other labels to each of two regions (clusters of pixels in the background color) inside “B.” As a result, the control portion 1 recognizes a series of pixels representing the character “B” as one component 6. Furthermore, the control portion 1 recognizes two semi-elliptical shapes inside “B” as separate components 6.

FIG. 6 shows a data portion representing the alphabet “C,” which results from dividing (is extracted from) the image data (see FIG. 2). With respect to this data portion, in the labeling process, the control portion 1 assigns identical labels to a series (cluster) of pixels representing the character (shape of) “C.” As a result, the control portion 1 recognizes the cluster of pixels representing the character “C” as one component 6.

FIG. 7 shows a data portion representing the alphabet “D,” which results from dividing (is extracted from) the image data (see FIG. 2). With respect to this data portion, in the labeling process, the control portion 1 assigns identical labels to a cluster (series) of pixels representing the character (shape of) “D.” Furthermore, the control portion 1 also assigns other labels to a cluster of pixels in the background color inside “D.” As a result, the control portion 1 recognizes the cluster of pixels representing the character “D” as one component 6. Furthermore, the control portion 1 recognizes a semi-elliptical shape inside “D” as another component 6.

As described above, the control portion 1 performs the labeling process with respect to image data so as to divide the image data into a plurality of components 6. The components 6 may include a character. The control portion 1 extracts, from among the components 6, a character component 6 including a character,

(Process Flow of Job Involving Readability Improving Process)

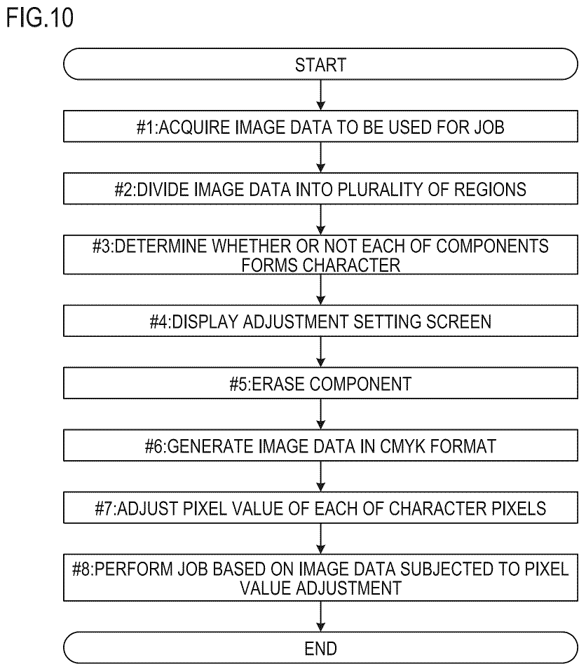

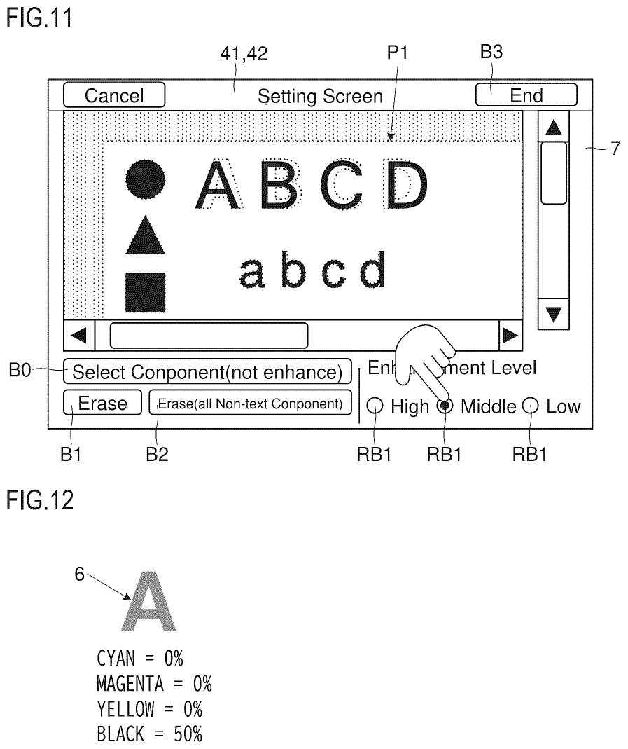

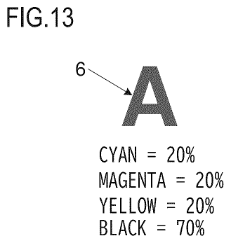

With reference to FIG. 10 to FIG. 13, a description is given of an example of a process flow of a job involving the readability improving process performed in the multi-functional peripheral 100 according to the embodiment. FIG. 10 is a view showing the example of the process flow of the job involving the readability improving process performed in the multi-functional peripheral 100 according to the embodiment. FIG. 11 is a view showing an example of an adjustment setting screen 7 according to the embodiment, FIG. 12 and FIG. 13 are views each showing an example of pixel value adjustment performed in the multi-functional peripheral 100 according to the embodiment.

In a job, the operation panel 4 accepts a selection as to whether or not to perform the readability improving process. FIG. 10 shows the example of the process flow in performing the readability improving process. In FIG. 10, “START” corresponds to a point in time when the job is started in a state where the selection has been made to perform the readability improving process. Instead of accepting the selection as to whether or not to perform the readability improving process, the control portion 1 may automatically preform, in every job, the readability improving process with respect to image data to be used for the job.

Here, the multi-functional peripheral 100 is capable of a copy job, a transmission job, and a saving job. The operation panel 4 accepts a selection of a job type and an instruction to start a job of the type thus selected. In the copy job, the control portion 1 controls the image reading portion 3 to read an original document and generates image data thereof. The control portion 1 is capable of performing the readability improving process with respect to the image data of the original document thus generated. The control portion 1 controls the printer portion 5 to perform printing based on the image data after being subjected to the readability improving process.

In the transmission job, the control portion 1 controls the image reading portion 3 to read an original document and generates image data thereof. The control portion 1 is capable of performing the readability improving process with respect to the image data of the original document thus generated. The control portion 1 controls the communication circuit part 14 to transmit, to a set destination, an image file based on the image data after being subjected to the readability improving process.

In the saving job, the control portion 1 controls the image reading portion 3 to read an original document and generates image data thereof. The control portion 1 is capable of performing the readability improving process with respect to the image data, of the original document thus generated. The control portion 1 performs control so that an image file based on the image data after being subjected to the readability improving process is stored at a set saving destination.

Furthermore, the multi-functional peripheral 100 is also capable of a print job. For example, when the communication circuit part 14 has received print job data from the computer 200, based on the print job data, the control portion 1 generates image data. The control portion 1 is capable of performing the readability improving process with respect to the image data thus generated. The control portion 1 controls the printer portion 5 to perform printing based on the image data after being subjected to the readability improving process.

First, the control portion 1 acquires image data to be used for a job (step 41). For example, in cases of the copy job, the transmission job, and the saving job, the control portion 1 controls the image reading portion 3 to read an original document. Based on an analog image signal outputted by the image reading portion 3, the control portion 1 generates image data of the original document thus read. In this manner, the image data to be used for a job is obtained. In a case of the print job, based on print job data, the control portion 1 generates image data. The control portion 1 controls the storage portion 2 to store the image data (the image data to be used for a job) thus acquired.

Next, the control portion 1 assigns labels to pixels in the acquired image data so as to divide the image data into a plurality of regions (step #2). That is, the control portion 1 performs the above-described labeling process. The control portion 1 recognizes each cluster of pixels assigned identical labels as one component 6 (region).

The control portion 1 determines whether or not each of components 6 forms a character (step 43). In determining whether or not each of the components 6 forms a character, for example, the control portion 1 encloses the each of the components 6 with a circumscribed rectangle. In the circumscribed rectangle enclosing the each of the components 6, the control portion 1 turns each pixel not included in the each of the components 6 into white pixels. Based on an image in the circumscribed rectangle, the control portion 1 performs an OCR (optical character recognition) process.

For example, in the OCR process, the control portion 1 may generate binarized image data of the image in the circumscribed rectangle. The control portion 1 normalizes a size of the binarized image data (sets the size to be prescribed). For example, the normalization is performed through an enlargement or reduction process. The control portion 1 performs a matching process with respect to the binarized image data after being normalized so as to recognize the character.

In a case of performing the matching process, the storage portion 2 stores template image data T1 in a non-volatile manner (see FIG. 1). The template image data T1 is character image data, and there are a plurality of types thereof. The template image data T1 is image data used for comparison (matching) with the binarized image data after being normalized. For example, based on a matching rate, the control portion 1 recognizes the character (the image in the circumscribed rectangle) formed by the each of the components 6. For example, in a case where none of pieces of the template image data T1 has a matching rate higher than a predetermined recognition threshold value D3, the control portion 1 determines that one of the components 6 corresponding to the binarized image data is not the character component 6. For example, the storage portion 2 stores the recognition threshold value D3 in a non-volatile manner (see FIG. 1). In a case where there is any character having a matching rate higher than the recognition threshold value D3, the control portion 1 determines that the one of the components 6 corresponding to the binarized image data is the character component 6.

The control portion 1 may determine a feature amount (feature vector) of the image in the circumscribed rectangle and, based on the feature amount thus determined, determine Whether or not the image is a character.

Next, the control portion 1 controls the operation panel 4 to display the adjustment setting screen 7 (step 44). The adjustment setting screen 7 is a screen for performing setting and display related to the readability improving process. FIG. 11 is a view showing an example of the adjustment setting screen 7.

The control portion 1 controls the display panel 41 to display a preview image P1. The preview image P1 is a view for predicting a completed state of a job. Based on image data obtained by reducing image data to be used for the job, the control portion 1 controls the display panel 41 to display the preview image P1. As shown in FIG. 11, in the preview image P1, the control portion 1 may perform control so that a boundary between recognized ones of the components 6 is indicated by a broken line.

The operation panel 4 may accept a selection of one of the components 6 not to be subjected to pixel value adjustment. For example, a component selection button B0 is provided on the adjustment setting screen 7. Pressing the component selection button B0 brings the operation panel 4 into a state enabling a selection of any of the components 6. In this state, a user touches one of the components 6 not to be subjected to pixel value adjustment. With respect to the selected one of the components 6 not to be subjected to the pixel value adjustment, even when the selected one is determined to be the character component 6, the control portion 1 does not perform the pixel value adjustment. Thus, it is possible not to adjust a density of a particular character component 6. It is possible to freely make a selection as to whether or not to increase a density of a color of a character.

Furthermore, the operation panel 4 may accept a selection of a level (an intensity, a pixel value adjustment amount) of pixel value adjustment with respect to a character. FIG. 11 shows an example in which there are three such levels of “High” (strong), “Middle” (normal), and “Low” (weak). As shown in FIG. 11, there may be provided an equal number of radio buttons RB1 to a number of levels. By operating any of the radio buttons RB1, a user can select a level of the readability improving process (pixel value adjustment). It is possible to select a degree to which a color of a character is to be increased. When the level “High” is selected, the control portion 1 sets an absolute value of the pixel value adjustment amount to be larger than that in a case where the level “Middle” (normal) or the level “Low” (weak) is selected. When the level “Middle” is selected, the control portion 1 sets the absolute value of the pixel value adjustment amount to be larger than that in the case where the level “Low” (weak) is selected. That is, the control portion 1 adjusts a pixel value of each of character pixels so as to correspond to a set level.

The operation panel 4 may accept a selection of one of the components 6 to be erased. For example, a first erase button B1 and a second erase button B2 are provided on the adjustment setting screen 7. Pressing the first erase button B1 brings the operation panel 4 into a state enabling a selection of any of the components 6. In this state, a user touches one of the components 6 desired to be erased. The control portion 1 changes a pixel value of the one of the components 6 selected to be erased to a pixel value corresponding to a predetermined erasure color. For example, by touching a black rectangle among figures in the preview image P1 shown in FIG. 11, it is possible to erase only the black rectangle. For example, the erasure color is white (pure white). The control portion 1 may generate a pixel value histogram so as to recognize a pixel value having a highest occurrence frequency as corresponding to a background color and change the pixel value of the one of the components 6 selected to be erased to the pixel value corresponding to the background color. It is possible to erase (make invisible) a particular component 6.

When the second erase button B2 is operated, the control portion 1 changes a pixel value of, among the components 6 included in the image data, all components 6 determined not to form characters to the pixel value corresponding to the erasure color. It is possible to erase all except for characters. For example, in the example shown in FIG. 11, by operating the second erase button B2, it is possible to collectively erase a black circle, a black triangle, and the black rectangle.

When the first erase button B1 or the second erase button B2 is operated, the control portion 1 performs a process for erasing any of the components 6 from the image data to be used for the job (step #5).

At the end of the process for erasing the one of the components 6 desired to be erased, an end button B3 on the adjustment setting screen 7 is operated to enable ending of setting on the adjustment setting screen 7. The operation panel 4 accepts an instruction to complete the setting on the adjustment setting screen 7. When the end button B3 is operated without the first erase button B1 or the second erase button B2 being operated, the control portion 1 skips step #5.

It is not necessary to perform setting on the adjustment setting screen 7. When there is no need to perform the setting, a user could operate the end button B3 immediately after the adjustment setting screen 7 is displayed.

Upon recognizing that the end button B3 has been operated, the control portion 1 converts a format of the image data to be used for the job so as to generate image data in a CMYK format (step 46). For example, the control portion 1 converts image data in the RGB format into image data in the CMYK format. For example, the storage portion 2 stores conversion table data TB1 in a non-volatile manner (see FIG. 1). The conversion table data TB1 is a table defining a correlation between an RGB pixel value and a CMYK pixel value. For example, for each RGB pixel value, there is defined a CMYK pixel value corresponding thereto. The correlation is defined so that a color in an RGB color space is appropriately reproduced in a CMYK color space. The control portion 1 refers to the conversion table data TB1 and uses it to generate image data in the CMYK format.

Subsequently, the control portion 1 adjusts a pixel value of each of character pixels, which are pixels constituting one of the components 6 determined to form a character (step #7). Specifically, the control portion 1 causes a pixel value of each of the character pixels for at least one color component to vary so that an increased density of the each of the character pixels is obtained. The control portion 1 causes a pixel value of each of the character pixels to vary so as to correspond to a selected level (intensity) of pixel value adjustment.

As shown in FIG. 12 and FIG. 13, the pixel value adjustment portion may change a pixel value of each of the character pixels for all color components of CMYK. As shown in FIG. 12 and FIG. 13, the control portion 1 may change the color components by an equal amount. Changing the color components by an equal amount is advantageous in that it prevents a tint of a character from varying largely.

For example, when the level of pixel value adjustment is “High,” the control portion 1 may increase a value (%) of each of C, M, Y, and K by 30%. When the level of pixel value adjustment is “Middle,” the control portion 1 may increase the value (%) of each of C, M, Y, and K by 20%. When the level of pixel value adjustment is “Low,” the control portion 1 may increase the value (%) of each of C. M, Y, and K by 10%.

FIG. 12 and FIG. 13 show examples in which the value (%) of each of C, M. Y, and K is increased by 20%. An alphabet A shown in FIG. 12 illustrates an example of a character before being subjected to pixel value adjustment. The alphabet A in FIG. 12 has a color composed of cyan=0%, magenta=0%, yellow=0%, and black=50%. An alphabet A shown in FIG. 13 illustrates an example of a character after being subjected to the pixel value adjustment. The alphabet A in FIG. 13 has a color composed of cyan=20%, magenta=20%, yellow=20%, and black=70%. FIG. 12 and FIG. 13 show examples in which a pixel value is increased by 20% for each of color components of cyan, magenta, yellow, and black. FIG. 12 and FIG. 13 show examples in which gray is adjusted to dark gray. When changing a color component, the control portion 1 does not increase a value thereof by a value higher than an upper limit value (100%).

As shown in FIG. 12 and FIG. 13, the color of the character is adjusted so that an increased density thereof is obtained. In other words, a contour of the character and an inside thereof are solidly colored in a dense color. As a result, the contour and a boundary of the character are made clearly identifiable. This increases ease of reading the character.

The pixel value adjustment portion may adjust a pixel value of each of the Character pixels for only one, two, or three color components among the color components of CMYK so that an increased density is obtained.

Further, based on the image data subjected to adjustment of a pixel value of each of the character pixels, the control portion 1 performs the job (step #8). For example, based on the image data after being subjected to the adjustment, the control portion 1 performs the copy job, the print job, the transmission job, or the saving job. The control portion 1 completes the job, thus ending a process related to a flow chart (“END”).

As described above, the image processing device (multi-functional peripheral 100) according to the embodiment includes the storage portion 2 and the pixel value adjustment portion (for example, the control portion 1). The storage portion 2 stores image data. Based on a pixel value of each of pixels included in the image data, the pixel value adjustment portion assigns labels to the pixels so as to divide the image data into a plurality of regions. With respect to each of the components 6 that is, among the pixels, a cluster of pixels assigned identical ones of the labels, the pixel value adjustment portion determines whether or not the each of the components 6 forms a character. The pixel value adjustment portion adjusts a pixel value of each of character pixels, which are pixels constituting the each of the components 6 when determined to form a character, so that an increased density is obtained.

With this configuration, by performing a process for assigning labels (the labeling process), it is possible to recognize each character (component 6) included in image data. Further, it is possible to adjust (change) a pixel value of each of pixels constituting each of the components 6 when determined to form a character so that an increased density of a color of the character is obtained. As a result, it is possible to increase a density of the color of the character. This makes a contour (boundary) of the character clearly identifiable. There is provided increased ease of reading the character (an improvement in readability). This makes a contour of any character clearly identifiable regardless of a pixel value, thus providing increased ease of reading a document. It is possible to obtain image data in which each character is increased in density, clearly identifiable, and easier to read compared with a case of performing image processing for adjusting contrast or brightness.

The pixel value adjustment portion converts the image data into image data in the CMYK format. The pixel value adjustment portion adjusts a pixel value of each of the character pixels for at least one of the color components of CMYK so that an increased density is obtained. Thus, it is possible to increase a density of a color of the each of the character pixels. This can increase ease of reading each character in the image data.

The pixel value adjustment portion may change the pixel value of each of the character pixels for all the color components. The pixel value adjustment portion Changes the color components by an equal amount. Thus, since the color components are changed by an equal amount, it is possible to increase a density of a color of a character while maintaining a tint of the character. For example, a bright blue character can be changed into a dense (dark) blue character.

The pixel value adjustment portion changes a pixel value of each of pixels constituting one of the components 6 determined not to form a character to a pixel value corresponding to a predetermined erasure color. Thus, in image data, the pixels constituting each of the components 6 when not forming a character can be automatically erased. Any data portion not representing a character can be colored in the erasure color so that a character stands out.

The pixel value adjustment portion changes a pixel value of, among the components 6, all components 6 determined not to form characters to the pixel value corresponding to the erasure color. Thus, it is possible to obtain image data in which anything but characters therein has been eliminated (colored in the erasure color). This can make a character stand out. There can be provided image data easier to read.

The erasure color may be white. Paper sheets are often white in color. By using white as the erasure color, any data portion presenting anything but a character can be colored in white. A color of a non-character pixel can be approximated to a color of a paper sheet. In a case where printing is performed based on image data after being subjected to pixel value adjustment, pixels in a data portion not representing a character are not printed.

The image processing device includes the operation panel 4 that accepts a selection of one of the components 6 not to be subjected to pixel value adjustment. The pixel value adjustment portion does not change a pixel value of each of pixels constituting the selected one of the components 6. Thus, it is possible not to adjust a color of a particular (selected) one of the components 6. It is possible to maintain a color of a particular character.

The image processing device includes the operation panel 4 that accepts a selection of a level of pixel value adjustment with respect to each of the character pixels. The pixel value adjustment portion changes a pixel value of the each of the character pixels so as to correspond to the selected level. Thus, it is possible to select a degree to which a color of a character recognized by the labeling process is to be adjusted. It is possible to set the color of the character after being subjected to the adjustment to a desired color.

The image processing device includes the image reading portion 3 that reads an original document. The storage portion 2 stores the image data obtained as a result of the image reading portion 3 reading the original document. Thus, it is possible to adjust a color of a character in the image data obtained by reading the original document. The character in the image data of the original document can be made clearly identifiable and easier to read.

While the foregoing has described the embodiment and modification examples of the present invention, the present invention is not limited in scope thereto and can be implemented by adding various changes thereto without departing from the spirit of the invention.

### Industrial Applicability

The present invention is usable in an image processing device and an image processing method.

1. An image processing device, comprising:
an operation panel;
a storage portion that stores image data; and
a pixel value adjustment portion that, based on a pixel value of each of pixels included in the image data, assigns labels to the pixels so as to divide the image data into a plurality of regions, with respect to each of components that is, among the pixels, a cluster of pixels assigned identical ones of the labels, determines whether or not the each of components forms a character, and adjusts a pixel value of each of character pixels, which are pixels constituting the each of components when determined to form a character, so that an increased density is obtained,
wherein
the operation panel displays an adjustment setting screen, and
the pixel value adjustment portion changes the pixel value of the each of character pixels so that the pixel value corresponds to a level selected on the adjustment setting screen.

2. The image processing device according to claim 1, wherein
the pixel value adjustment portion converts the image data into image data in a CMYK format, and
the pixel value adjustment portion adjusts a pixel value of each of the character pixels for at least one of color components of CMYK so that an increased density is obtained.

3. The image processing device according to claim 2, wherein
the pixel value adjustment portion changes the pixel value of each of the character pixels for all the color components, and
the pixel value adjustment portion changes the color components by an equal amount.

4. The image processing device according to claim 1, wherein
the pixel value adjustment portion changes a pixel value of each of pixels constituting one of the components determined not to form a character to a pixel value corresponding to a predetermined erasure color.

5. The image processing device according to claim 4, wherein
the pixel value adjustment portion changes a pixel value of, among the components, all components determined not to form characters to the pixel value corresponding to the erasure color.

6. The image processing device according to claim 4, wherein
the erasure color is white.

7. The image processing device according to claim 1, wherein
the operation panel accepts a selection of one of the components not to be subjected to pixel value adjustment, and
the pixel value adjustment portion does not change a pixel value of each of pixels constituting the selected one of the components.

8. (canceled)

9. The image processing device according to claim 1, further comprising:
an image reading portion that reads an original document,
wherein the storage portion stores the image data obtained as a result of the image reading portion reading the original document.

10. An image processing method, comprising:
storing image data;
assigning, based on a pixel value of each of pixels included in the image data, labels to the pixels so as to divide the image data into a plurality of regions;
determining, with respect to each of components that is, among the pixels, a duster of pixels assigned identical ones of the labels, whether or not the each of components forms a character;
adjusting a pixel value of each of character pixels, which are pixels constituting the each of components when determined to form a character, so that an increased density is obtained;
controlling an operation panel to display an adjustment setting screen; and
changing the pixel value of the each of character pixels so that the pixel value corresponds to a level selected on the adjustment setting screen.

11. The image processing device according to claim 1, wherein
the level is selectable from among at least three levels displayed on the adjustment setting screen, and
an adjustment amount of the pixel value of the each of character pixels is set so as to correspond to the selected level.
